(19) United States
(12) Patent Application Publication
(10) Pub. No.: US 2012/0156054 A1
(43) Pub. Date: Jun. 21, 2012

(54) TURBINE COMPONENT WITH NEAR-SURFACE COOLING PASSAGE AND PROCESS THEREFOR

(75) Inventors: Benjamin Paul Lacy, Greer, SC (US); David Vincent Bucci, Simpsonville, SC (US); Srikanth Chandrudu Kottilingam, Simpsonville, SC (US); Dennis William Cavanaugh, Simpsonville, SC (US)

(73) Assignee: GENERAL ELECTRIC COMPANY, Schenectady, NY (US)

(21) Appl. No.: 12/968,410

(22) Filed: Dec. 15, 2010

(51) Int. Cl. F01D 5/18; B22D 23/00; B05D 3/12

(52) U.S. Cl. 416/96 R; 427/300; 164/76.1

(57) ABSTRACT

A process for creating a near-surface cooling passage in an air-cooled turbomachine component. The process entails forming a channel in a surface of a surface region of the component so that the channel is open at the surface and fluidically connected to a first cooling passages within the component. A metallic layer is then deposited on the surface and over the channel without filling the channel. The metallic layer closes the channel at the surface of the surface region to define therewith a second cooling passage within the component that is fluidically connected to the first cooling passages. A coating system is then deposited on the metallic layer to define an outermost surface of the component. The second cooling passage is closer to the outermost surface of the component than the first cooling passages.

### BACKGROUND OF THE INVENTION

The present invention relates to components that operate at high temperatures, such as turbine airfoil components of turbomachinery. More particularly, this invention relates to a process of creating near-surface cooling channels in high-temperature components to promote the heat transfer characteristics of the components.

Components of turbomachinery, such as buckets (blades), nozzles (vanes), and other hot gas path components of industrial and aircraft gas turbine engines, are typically formed of nickel, cobalt or iron-base superalloys with desirable mechanical and environmental properties for turbine operating temperatures and conditions. Because the efficiency of a turbomachine is dependent on its operating temperatures, there is a demand for components such as turbine buckets and nozzles to be capable of withstanding increasingly higher temperatures. As the maximum local temperature of a superalloy component approaches the melting temperature of the superalloy, forced air cooling becomes necessary. For this reason, airfoils of gas turbine buckets and nozzles often require complex cooling schemes in which air, typically bleed air, is forced through internal cooling passages within the airfoil and then discharged through cooling holes at the airfoil surface to transfer heat from the component. Cooling holes can also be configured so that cooling air serves to film cool the surrounding surface of the component.

Buckets and nozzles formed by casting processes require cores to define the internal cooling passages. The cores and their potential for shifting during the casting process limits the extent to which a conventional casting process can locate a cooling passage in proximity to an exterior surface of the component. As a result, cooling passages are typically about 0.1 inch (about 2.5 millimeters) or more below a base metal surface of a cast turbine bucket or nozzle. However, the heat transfer efficiency could be significantly increased if the cooling passages could be placed closer to the surface than is currently possible.

### BRIEF DESCRIPTION OF THE INVENTION

The present invention provides a process for creating one or more near-surface cooling passages in an air-cooled turbomachine component, notable but nonlimiting examples of which include buckets (blades), nozzles (vanes), shrouds, and other hot gas path components of gas turbines.

According to a first aspect of the invention, the process entails forming a channel in a surface of a surface region of the component, so that the channel is open at the surface and fluidically connected to a first cooling passage within the component. A metallic layer is then deposited on the surface and over the channel without filling the channel. The metallic layer closes the channel at the surface of the surface region to define therewith a second cooling passage within the component that is fluidically connected to the first cooling passage and is closer to an outer surface of the metallic layer than the first cooling passage. A coating system is then deposited on the metallic layer to define an outermost surface of the component. The second cooling passage is closer to the outermost surface of the component than the first cooling passage.

Another aspect of the invention is a component formed by a process comprising the steps described above.

A technical effect of the invention is the ability to place a cooling passage within a cast component that is much closer to the component surface than cooling passages created with cores during the casting process. As a result, the invention has the capability of significantly increasing the heat transfer efficiency of a component, and particularly an air-cooled turbomachine component located in the hot gas path of a gas turbine engine.

Other aspects and advantages of this invention will be better appreciated from the following detailed description.

### BRIEF DESCRIPTION OF THE DRAWINGS

FIG. 1 is a perspective view of a high pressure turbine bucket of a type that can benefit from the present invention.

FIG. 2 represents a partial cross-sectional view of a surface region of the bucket of FIG. 1, and depicts multiple channels defined in the surface of the surface region in accordance with an embodiment of this invention.

FIG. 3 is a cross-sectional view representing a layer deposited over the channels of FIG. 2.

FIG. 4 is a cross-sectional view representing an aluminized surface region in the layer of FIG. 3.

FIG. 5 is a cross-sectional view representing a bond coat and thermal barrier coating deposited on the aluminized surface region in the layer of FIG. 4.

FIG. 6 is a cross-sectional view representing a thermal barrier coating deposited directly on the aluminized surface region in the layer of FIG. 4.

### DETAILED DESCRIPTION OF THE INVENTION

The present invention is generally applicable to components that operate within environments characterized by relatively high temperatures, and particularly a component whose maximum surface temperature approaches the melting temperature of the material from which it is formed, necessitating the use of forced air cooling to reduce the component surface temperature. Notable examples of such components include the high and low pressure turbine buckets (blades), nozzles (vanes), shrouds, and other hot gas path components of a turbomachine, such as an industrial or aircraft gas turbine engine.

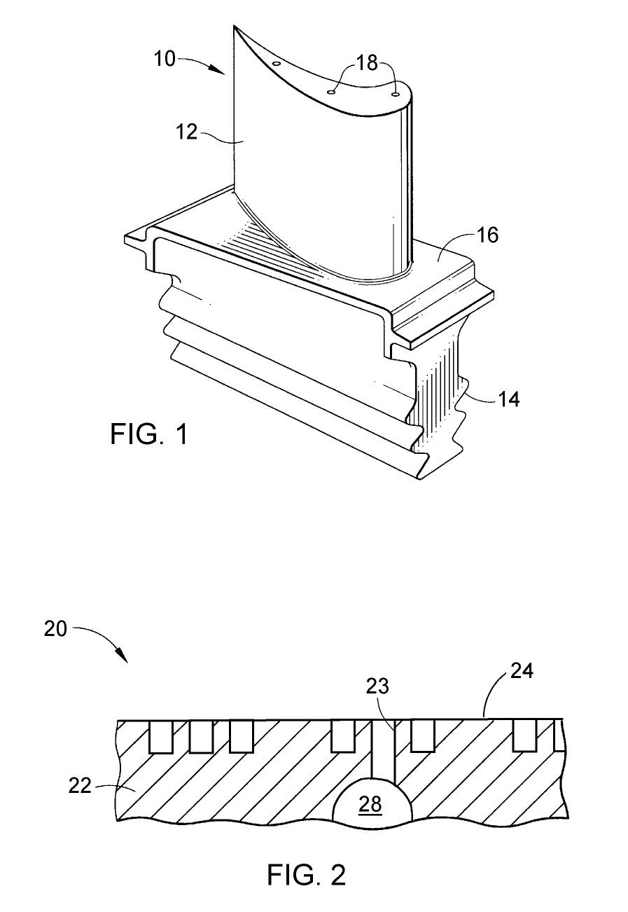

A nonlimiting example of a turbine bucket 10 is represented in FIG. 1. The bucket 10 generally includes an airfoil 12 against which hot combustion gases are directed during operation of the gas turbine engine, and whose surface is therefore subjected to very high temperatures. The airfoil 12 is represented as configured to be anchored to a turbine disk (not shown) with a dovetail 14 formed on a root section of the bucket 10 that is separated from the airfoil 12 by a platform 16. The airfoil 12 includes cooling holes 18 through which bleed air that enters the bucket 10 through its root section is forced to transfer heat from the bucket 10. While the advantages of this invention will be described with reference to the bucket 10 shown in FIG. 1, the teachings of this invention are generally applicable to other hot gas path components of industrial and aircraft gas turbine engines, as well as a variety of other components that subjected to extreme temperatures.

FIG. 2 represents an external surface region 22 of the bucket 10, for example, a surface region of the airfoil 12 or platform 16 of the airfoil 12 in FIG. 1. The surface region 22 is typically the base material of the bucket 10, for example, a nickel-, cobalt- or iron-based superalloy, notable but nonlimiting examples of which include nickel-based superalloys such as GTD-111® (General Electric Co.), GTD-444® (General Electric Co.), IN-738, René N4, René N5 and René 108. The bucket 10 may be formed as an equiaxed, directionally solidified (DS), or single crystal (SX) casting to withstand the high temperatures and stresses to which it is subjected within a gas turbine engine. Melting and casting processes suitable for producing the bucket 10 are well known and therefore will not be discussed here in any detail.

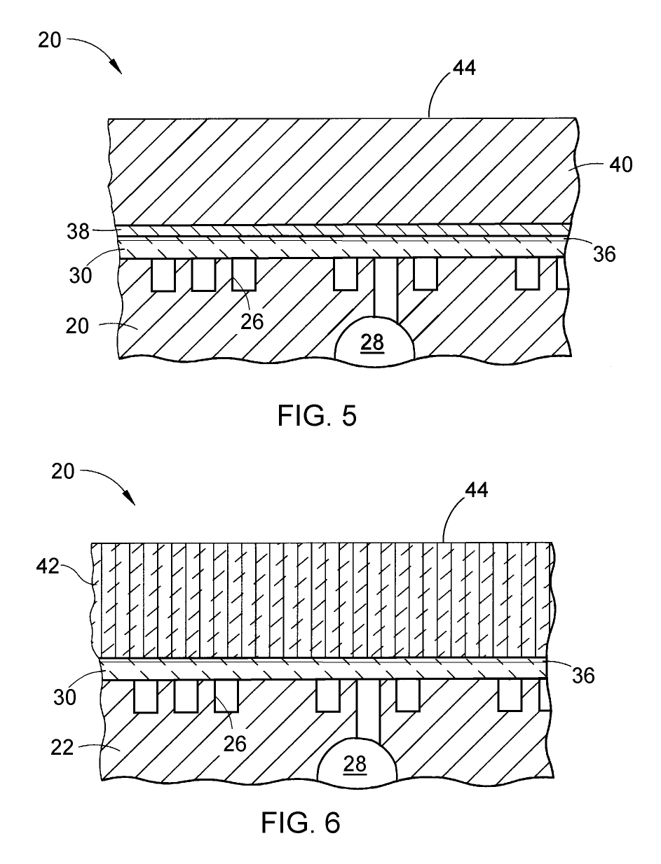

FIG. 2 further represents multiple channels 23 that have been defined in the surface region 22 so that the channels 23 are open at the surface 24 of the region 22. The channels 23 will subsequently define near-surface cooling passages (FIGS. 5 and 6) within the bucket 10, and therefore are desired to have a sufficient cross-sectional area to allow cooling air, such as compressor bleed air, to flow therethrough. For example, the channels 23 preferably have a width and depth (parallel and normal to the surface 24, respectively) of up to about 0.1 inch (about 2.5 mm), with a typical range of about 0.01 to about 0.050 inch (about 0.25 to about 1.25 mm), though lesser and greater widths and depths are possible. Furthermore, the channels 23 preferably have a cross-sectional area of up to about 0.01 in² (about 6.5 mm²), for example, about 0.0001 to about 0.0025 inch (about 0.065 to about 1.6 mm²). The channels 23 are represented as having a rectangular cross-section, though it is foreseeable that cross-sectional shapes other than rectangular could be achieved for the channels 23. However, a rectangular cross-section will be produced by various methods by which the channels 23 can be readily defined in the surface region 22, for example, milling, wire EDM, milled EDM, waterjet trenching, and laser trenching. The channels 23 are represented as being formed in sets whose individual channels 23 are closer to each other than to channels 23 of adjacent sets. However, this configuration is not necessary, and other configurations are foreseeable.

The channels 23 are formed in the surface 24 of the region 22 so as to be fluidically coupled to one or more cooling passages 28 (one of which is depicted in FIGS. 2-6) that are located deeper beneath the surface 24, as represented in FIG. 2. The cooling passage 28 receive cooling air, such as compressor bleed air, though one or more openings (not shown) in the root section of the bucket 10, and then supply the cooling air to the channels 23 as well as the cooling holes 18. As such, each cooling passage 28 preferably has a larger cross-sectional area than any of the channels 23. The cooling passage 28 can be formed by conventional methods, for example, with cores employed in traditional casting methods used to cast the bucket 10. The proximity of the cooling passage 28 relative to the cast surface 24 of the bucket 10 and eventually any outermost surface formed by a coating on the bucket 10 is limited by the ability to accurately place a core and maintain its position during the casting process, and in most cases will be about 0.1 inch (about 2.5 millimeters) or more from the casting surface 24.

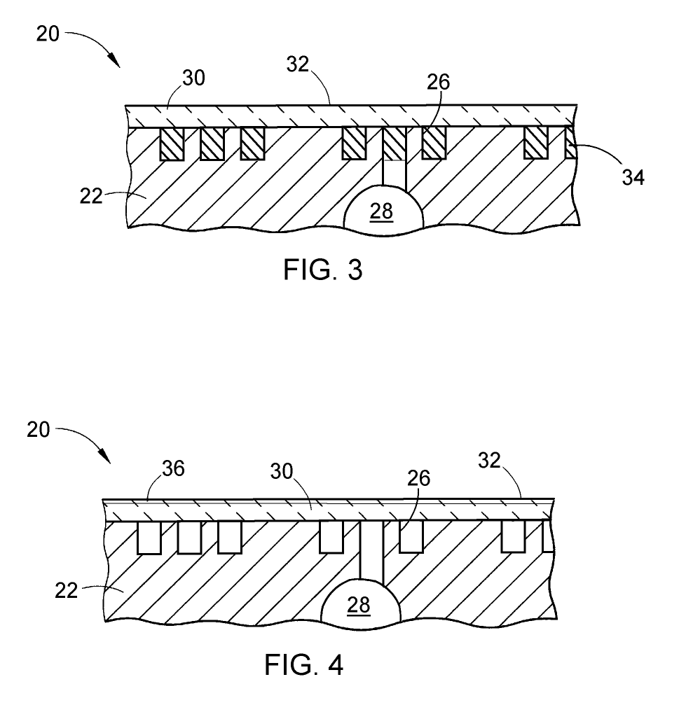

FIG. 3 represents the result of applying a layer 30 over the casting surface 24 and its channels 23 to close the channels 23 at the surface 24. The layer 30 can be applied over any portion of the bucket 10, and particularly any external surfaces of the bucket 10, though it is also possible to employing masking techniques so that the layer 30 is applied to just those surfaces of the bucket 10 in which the channels 23 are formed. As evident from FIG. 3, the channels 23 and layer 30 cooperate to define passages 26 that are internal to the bucket 10. Because the channels 23 are separated from the surface 32 of the layer 30 by only the thickness of the layer 30, the passages 26 are closer to the surface 32 of the layer 30 than the cooling passage 28 through which the passages 26 are fed cooling air.

The layer 30 is preferably applied by a plating process to tightly adhere to the surface 24. Notable plating techniques include electroplating and electroless plating, which are well known and therefore do not require any detailed discussion. To avoid plating material being deposited in the channels 23, FIG. 3 further represents the channels 23 as being filled with a filler or masking material 34. The masking material 34 is present during the deposition of the layer 30, but is otherwise absent from the passages 26 prior to placing the bucket 10 in service. As such, the masking material 34 is preferably capable of being removed at some point after the layer 30 has been deposited, such as by melting the masking material 34. Nonlimiting examples of suitable materials for this purpose include waxes, graphite, and other materials capable of filling the channels 23 and being plated over, while remaining removal by chemical or thermal treatments. As such, it is foreseeable that a variety of materials could be developed or otherwise identified for use as the masking material 34. Plating methods are believed to be preferred processes for depositing the layer 30 in view of their relatively low processing temperatures that avoid prematurely melting the masking material 34, the ability to plate surfaces of relatively complex shapes, the ability to accurately control the thickness of the deposited layer 30, and the variety of materials that can be deposited by plating. However, it may be possible to adapt certain plasma spray techniques or brazing techniques to form the layer 30.

The composition of the layer 30 is preferably chemically and physically compatible with the material of the surface region 22. As such, a particularly notable material for the layer 30 is nickel, a nickel-containing alloy, or a nickel-based alloy if the surface region 22 is formed of a nickel-based superalloy. For example, nickel can be deposited by a process by which particles of other elements can be dispersed in a nickel-based matrix. One such process is taught in U.S. Published Patent Application No. 2003/0211239, by which particles of chromium, aluminum, zirconium, hafnium, titanium, tantalum, silicon, calcium, iron, yttrium and/or gallium can be incorporated into a plated layer of nickel, cobalt and/or iron by a plating process. A desirable nickel-containing alloy that can be produced by a plating process is an MCrAlY-type coating, such as NiCoCrAlY. The thickness of the layer 30 affects the ability of cooling air flow through the passages 26 to cool the external surfaces of the bucket 10 subjected to the hot gas path. As such, the thickness of the layer 30 will typically be about 0.01 inch (about 250 micrometers) or less, though greater thicknesses are foreseeable. The thickness of the layer 30 will also affect the structural integrity of the surface region 22, and as such a minimum thickness for the layer 30 will typically be about 0.005 inch (about 125 micrometers). While the composition of the layer 30 will determine its strength and thermal conductivity, it is believed that thicknesses in a range of about 0.005 to about 0.01 inch (about 125 to about 250 micrometers) will typically be suitable.

FIG. 4 represents the result of removing the masking material 34 from the passages 26 and aluminizing the surface 32 of the layer 30 to form an aluminum-containing region 36 within the surface 32 of the layer 30. The region 36 may be termed aluminum-rich, denoting that the region 36 contains a greater amount of aluminum (in atomic percent) than the substrate in which it is formed. The aluminizing process deposits aluminum and likely forms aluminides (aluminum intermetallics) on and beneath the surface 32 of the layer 30. Various processes can be used to form the aluminum-containing region 36, examples of which include those disclosed in U.S. Published Patent Application Nos. 2009/0214773 and 2009/0126833, though various other diffusion aluminide processes can be used similar to what is used to form diffusion aluminide bond coats and environmental coatings.

The aluminizing of the surface 32 of the layer 30 is an optional but preferred step for several reasons relating to coating systems represented in FIGS. 5 and 6. In FIG. 5, a bond coat 38 is represented as having been deposited directly on the aluminum-containing region 36, followed by a thermal barrier coating (TBC) 40 deposited on the bond coat 38. In FIG. 6, a thermal barrier coating 42 is represented as having been deposited directly on the aluminum-containing region 36, without an intervening bond coat. Typical but nonlimiting materials for the thermal barrier coatings 40 and 42 are ceramic materials, a notable example of which is zirconia partially or fully stabilized with yttria (YSZ) or another oxide such as magnesia, ceria, scandia and/or calcia, and optionally other oxides to reduce thermal conductivity. The thermal barrier coatings 40 and 42 are deposited to a thickness that is sufficient to provide a desired level of thermal protection for the underlying surface region 22 of the bucket 10, generally on the order of about 75 to about 300 micrometers, though lesser and greater thicknesses are also possible.

As is typical with TBC systems for components of gas turbine engines, the bond coat 38 is preferably an aluminum-containing composition, for example, an overlay coating such as MCrAlX (where M is iron, cobalt and/or nickel, and X is yttrium, rare earth metals, and/or reactive metals), though the use of other bond coat compositions are also foreseeable. Aluminum-containing bond coats such as MCrAlX naturally develop an aluminum oxide (alumina) scale (not shown), which is capable of inhibiting oxidation of the surface it covers (such as the surface 32 of the layer 30), as well as capable of chemically bonding the thermal barrier coating 40 to the bond coat 38. Particularly suitable MCrAlX coating materials typically contain about 5 weight percent or more of aluminum, though MCrAlX coatings containing less than 5 weight percent aluminum could also be used. The bond coat 38 typically has a thickness of about 12 to about 75 micrometers, though lesser and greater thicknesses are also possible. The bond coat 38 can be deposited by various processes, such as physical vapor deposition (PVD) processes and thermal spraying, with preferred processes believed to be thermal spray processes such as plasma spraying, HVOF (high velocity oxy-fuel) and wire arc spraying.

If the layer 30 does not contain any aluminum, for example, a nickel or nickel alloy, the aluminum within the bond coat 38 is prone to diffuse into the layer 30, depleting the aluminum content in the bond coat 38. Eventually, the level of aluminum within the bond coat 38 could be sufficiently depleted to prevent further slow growth of the protective scale, allowing for the more rapid growth of nonprotective oxides and thereby reducing the ability of the bond coat 38 to provide oxidation resistance to the surface region 22 and adhere the thermal barrier coating 40. Consequently, by creating the aluminum-containing region 36 within the surface 32 of the layer 30, the chemical gradients that promote diffusion of aluminum from the bond coat 38 are reduced.

In the embodiment of FIG. 6, the aluminum-containing region 36 replaces the bond coat 38 of FIG. 5, and an alumina scale that grows on the region 36 provides oxidation resistance and promotes the adhesion of the thermal barrier coating 42. In this embodiment, the aluminum-containing region 36 is preferably deposited by a diffusion process to contain platinum aluminide (PtAl) intermetallics.

The thermal barrier coatings 40 and 42 are represented in FIGS. 5 and 6 as having different structures. The coating 40 represented in FIG. 5 is deposited by a thermal spraying process, such as air plasma spraying (APS), by which softened particles deposit as “splats” on the deposition surface formed by the bond coat 38, and result in the coating 40 having noncolumnar, irregular flattened grains and a degree of inhomogeneity and porosity. This category of thermal barrier coating includes coatings referred to as dense vertically cracked (DVC) TBCs, which are deposited by plasma spraying to have vertical microcracks to improve durability, as reported in U.S. Pat. Nos. 5,830,586, 5,897,921, 5,989,343 and 6,047,539. On the other hand, the coating 42 represented in FIG. 6 is deposited by a PVD process, such as electron beam physical vapor deposition (EBPVD), which yields a columnar grain structure that is able to expand and contract without causing damaging stresses that lead to spallation. Alternatively, the coating 42 of FIG. 6 could be deposited as a thin film by a low pressure plasma spraying (LPPS) process, also known as vacuum plasma spraying (VPS).

As a result of the process steps described above, the passages 26 defined by the channels 23 and layer 30 within the bucket 10 are near-surface cooling passages 26 that are closer to the outermost surface 44 of the bucket 10 (defined by one of the thermal barrier coatings 40 or 42) than the cooling passage 28 formed by conventional core methods during casting of the bucket 10. Openings (not shown) may be formed in the passages 26 through which cooling air from the passage 28 is vented to the exterior of the bucket 10, or the passages 26 may be fluidically connected to the cooling holes 18 present in the airfoil 12. Because the distance between each passage 26 and the outermost surface 44 is determined by the layer 30, bond coat 38 (if present), and thermal barrier coating 40 or 42, and the combined thicknesses of these layers can be controlled by their respective deposition processes, the passages 26 can be two millimeters or less below the outermost surface 44 of the bucket 10, more preferably about one millimeter or less below the outermost surface 44 for example, and can even be about 200 micrometers and less below the bucket's outermost surface 44, each of which is significantly less than that possible with the conventional cooling passage 28 formed by a core using a traditional casting method. As such, the passages 26 are able to significantly increase the heat transfer efficiency of the bucket 10 in comparison to the cooling passage 28.

While the invention has been described in terms of particular embodiments, it is apparent that other forms could be adopted by one skilled in the art. Therefore, the scope of the invention is to be limited only by the following claims.

1. A process of providing cooling passages in a hot gas path component of a turbomachine, the process comprising:
forming a channel in a surface of a surface region of the component, the channel being open at the surface and being fluidically connected to a first cooling passages within the component;
depositing a metallic layer on the surface and over the channel without filling the channel, the metallic layer closing the channel at the surface of the surface region to define therewith a second cooling passage within the component that is fluidically connected to the first cooling passages and is closer to an outer surface of the metallic layer than the first cooling passages; and
depositing a coating system on the metallic layer, the coating system defining an outermost surface of the component, the second cooling passage being closer to the outermost surface of the component than the first cooling passages.

2. The process according to claim 1, wherein the second cooling passage is not more than two millimeters from the outermost surface of the component.

3. The process according to claim 1, wherein the second cooling passage is not more than one millimeter from the outermost surface of the component.

4. The process according to claim 1, wherein the second cooling passage has a cross-sectional area of less than the first cooling passages.

5. The process according to claim 1, wherein the forming step comprises forming the channel as one of a set of channels that are formed in the surface of the surface region of the component, open at the surface, and fluidically connected to the first cooling passages within the component, and the step of depositing the metallic layer results in the metallic layer being deposited over all of the channels and without filling the channels so that each of the channels is closed by the metallic layer at the surface of the surface region to define therewith one of a plurality of the second cooling passage within the component.

6. The process according to claim 1, further comprising:
depositing a masking material in the channel prior to the step of depositing the metallic layer; and
removing the masking material from the channel after the step of depositing the metallic layer.

7. The process according to claim 1, wherein the metallic layer has a maximum thickness of 250 micrometers.

8. The process according to claim 1, wherein the metallic layer is deposited by a plating process.

9. The process according to claim 1, wherein the metallic layer has a composition chosen from the group consisting of nickel, nickel-containing alloys, and nickel-based alloys.

10. The process according to claim 9, further comprising the step of aluminizing the outer surface of the metallic layer to form an aluminum-containing region in the outer surface prior to depositing the coating system on the metallic layer.

11. The process according to claim 1, wherein the coating system comprises a metallic bond coat deposited on the metallic layer and a ceramic coating deposited on the bond coat.

12. The process according to claim 11, wherein the bond coat has an aluminum content of at least five weight percent, the process further comprising aluminizing the outer surface of the metallic layer prior to depositing the bond coat on the metallic layer.

13. The process according to claim 1, wherein the coating system comprises a ceramic coating deposited directly on the metallic layer, the process further comprising the step of aluminizing the outer surface of the metallic layer prior to depositing the ceramic coating on the metallic layer.

14. The process according to claim 1, wherein the component is formed by a casting process that simultaneously forms the first cooling passage within the component.

15. The process according to claim 1, wherein the component is a turbine airfoil component and the turbomachine is a gas turbine engine.

16. The process according to claim 15, wherein the component is a turbine bucket or a turbine nozzle.

17. A process of providing cooling passages in a turbine airfoil component formed of a nickel-based superalloy, the process comprising:
casting a nickel-based superalloy to form the airfoil component and a first cooling passages within the airfoil component;
forming a plurality of channels in a surface of an airfoil surface region of the airfoil component, the channels being open at the surface and being fluidically connected to the first cooling passages within the airfoil component;
depositing a masking material in the channels;
depositing a nickel-containing layer on the surface and over the channels and the masking material therein without filling the channels, the nickel-containing layer being deposited by a plating process to have a thickness of not more than 250 micrometers, the nickel-containing layer closing the channels at the surface of the airfoil surface region to define therewith second cooling passages within the airfoil component that are fluidically connected to the first cooling passages and are closer to an outer surface of the nickel-containing layer than the first cooling passages;
removing the masking material from the channels;
aluminizing the outer surface of the nickel-containing layer to form an aluminum-rich region in the outer surface; and
depositing a coating system on the nickel-containing layer, the coating system defining an outermost surface of the airfoil component, the second cooling passages being closer to the outermost surface of the airfoil component than the first cooling passages.

18. A hot gas path component of a turbomachine, the component comprising:
a channel in a surface of a surface region of the component, the channel being fluidically connected to a first cooling passages within the component;
a metallic layer on the surface and over the channel without filling the channel, the metallic layer closing the channel at the surface of the surface region to define therewith a second cooling passage within the component that is fluidically connected to the first cooling passages and is closer to an outer surface of the metallic layer than the first cooling passages; and
a coating system on the metallic layer, the coating system defining an outermost surface of the component, the second cooling passage being closer to the outermost surface of the component than the first cooling passages.

19. The hot gas path component according to claim 18, wherein the second cooling passage is not more than two millimeters from the outermost surface of the component.

20. The hot gas path component according to claim 18, wherein the component is a turbine bucket or a turbine nozzle.
